(19) United States
(12) Patent Application Publication
(10) Pub. No.: US 2001/0046932 A1
(43) Pub. Date: Nov. 29, 2001

(54) Apparatus for folding folding products

(76) Inventor: Martin Bluemle, Horhausen (DE)

Correspondence Address: FASSE PATENT ATTORNEYS, P.A., P.O. BOX 726, HAMPDEN, ME, 04444-0726, US

(21) Appl. No.: 09/858,088

(22) Filed: May 15, 2001

(30) Foreign Application Priority Data
May 16, 2000 (DE) 100 23 712.6

(51) Int. Cl. B31F 1/08

(52) U.S. Cl. 493/424

(57) ABSTRACT

The invention relates to a method and an apparatus for folding folding products with sealing flaps and with or without mating flaps, in particular on packaging bags including envelopes with/without self-adhesive glue, it being possible for the envelopes to be moved against a stationary stop and for the mating flaps and the sealing flaps then to be turned over by suction elements during a subsequent movement of the envelopes, said suction elements being arranged on a mating flap roll and on a sealing flap roll.

The core of the idea consists in the radius of the mating flap roll, which bears the suction element that turns the mating flaps over, being at least partly small, and that the mating flap roll can be locked, both in such a way that a folding product can be moved past it to the stationary stop without contact or virtually without contact.

### DESCRIPTION

The invention relates to an apparatus for folding folding products with sealing flaps and with or without mating flaps, especially on packaging bags including envelopes, having the features of the preamble of claim 1.

For many years, apparatus of the type of interest here have been on the market and are used to a great extent in the production of packaging bags including envelopes. In order to fold over the mating flaps and the sealing flaps, the almost completed packaging bags or envelopes are held against a stop and then, during the following opposing movement, are folded over with the aid of suction elements on a mating flap roll or on a sealing flap roll and then transported onward and, for example, deposited with the aid of a paddle wheel.

Furthermore, DE 22 18 085 C2 discloses an apparatus for folding the sealing and mating flaps on envelopes with self-adhesive glue, the flaps being lifted and turned over with the aid of two suction rolls. In addition, a recess is arranged in one suction roll and, adjacent thereto, a suction bar.

The apparatus disclosed by DE 22 18 085 C2 operates considerably more slowly than the folding apparatus on the market and, for this reason, is technically obsolete. Added to this is the fact that the folding apparatus on the market is also suitable for the production of other envelopes which do not have any self-adhesive glue on the sealing flap and instead, have a contact adhesive which becomes effective when moistened, and also no mating flap. For this purpose, however, a suction roll, that is to say the suction roll with the suction element for the mating flap, together with its drive, has to be pivoted completely out of the movement path of the folding product to be completed or the envelope to be completed. The technical outlay associated with this is considerable and is to be avoided.

In order to achieve this object, the invention having the features of the characterizing clause of claim 1 proposes that the radius of the mating flap roll, which bears the suction element that turns the mating flaps over, be at least partly small, and that the mating flap can be locked, both in such a way that a folding product can be moved past it to the stationary stop even without contact or virtually without contact.

With the aid of the aforementioned features it is possible, on one and the same apparatus, to produce packaging bags including envelopes with a sealing flap and mating flap, on the one hand, or only with a sealing flap, on the other hand, converting the apparatus not being required and only the mating flap roll having to be stopped in a defined position. The defined position is given when the packaging bag or the envelope can move from the sealing flap roll in the direction of the stationary stop without in so doing significantly touching the mating flap roll. It is therefore possible for various types of envelopes to be completed without difficulty on one and the same machine. The features provided for this purpose according to the invention are not only technically less complicated and also cheaper in terms of production, but they can also be handled more quickly and more simply than the comparable measures according to the prior art.

In addition, the invention provides for at least one suction element to be arranged on the mating flap roll and to project beyond a cylindrical circumference of the mating flap roll. The suction element is no longer integrated in the circumference of the mating flap roll - as in the prior part - and ends at least partly flush with the latter, instead it is elevated like a driver or finger beyond the circumference of the mating flap roll. Nevertheless, during the production of envelopes with self-adhesive glue on both flaps, the suction element is able to grip the mating flap to be turned over by it both securely and reliably, in particular since the envelope is at the same time still stabilized with the aid of the sealing flap roll. In this case, the suction element of the sealing flap roll only releases the sealing flap when the suction element of the mating flap roll has folded over the mating flap completely or virtually completely.

Further features of the invention emerge from subclaims and the description in conjunction with the drawing.

The invention will be described in more detail below using an exemplary embodiment which is illustrated in the drawing, in which:

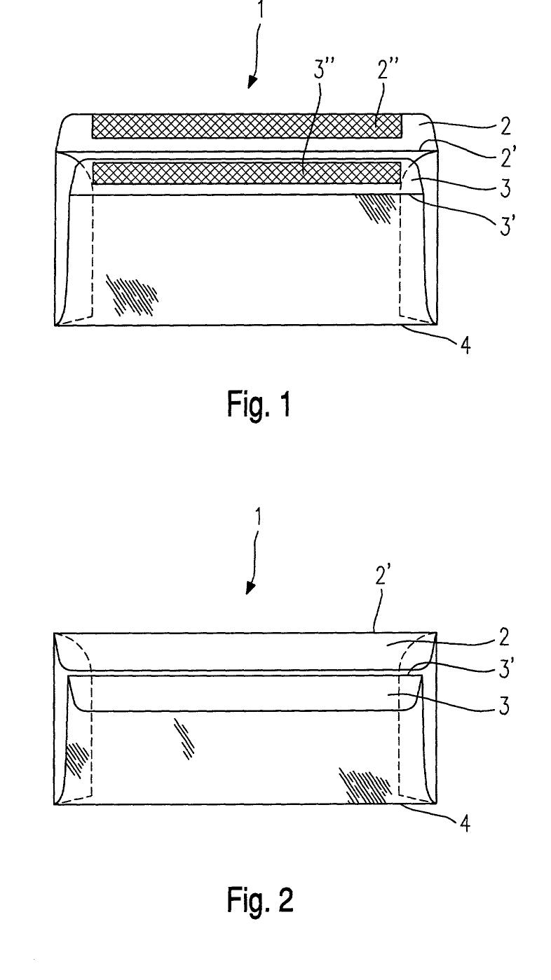

FIG. 1: shows a plan view of the rear of an envelope with self-adhesive glue and with sealing and mating flaps not yet folded over;

FIG. 2: shows a plan view of the rear of the envelope as in FIG. 1 after the sealing and mating flaps have been folded over;

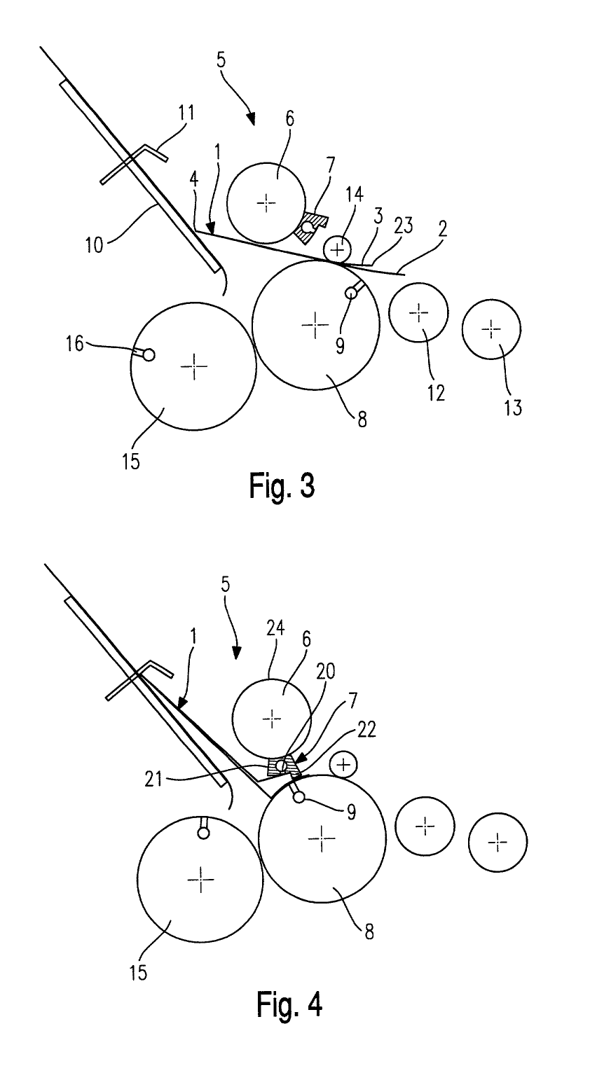

FIG. 3: shows a side view of a basic sketch of the apparatus before the suction elements grip the mating flap and the sealing flap;

FIG. 4: shows a side view as in FIG. 3 immediately before the suction elements fold the mating flap and the sealing flap over;

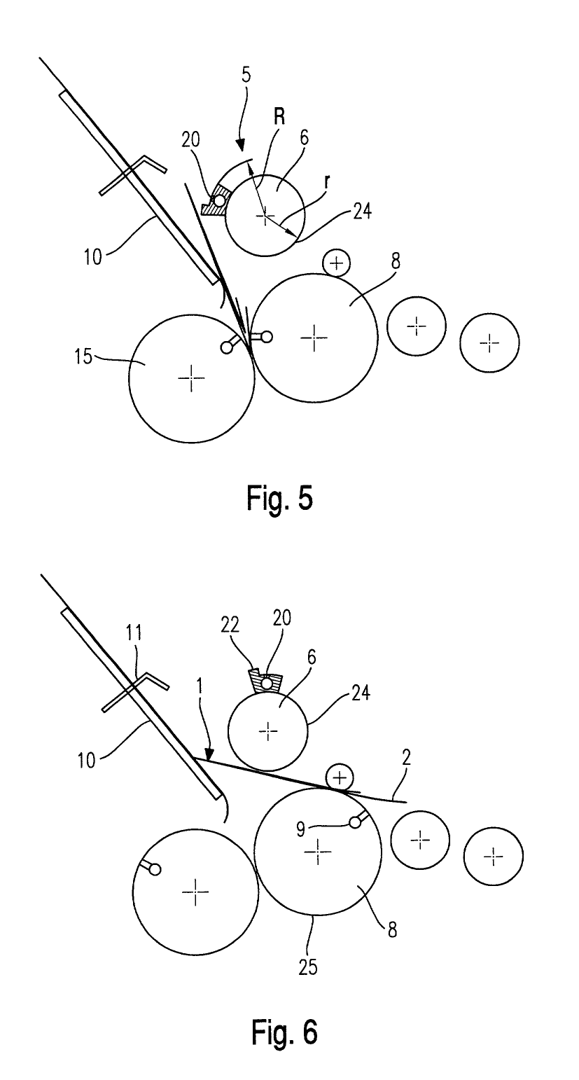

FIG. 5: shows a side view of the apparatus as in FIGS. 3 and 4 with the sealing and mating flaps folded over and

FIG. 6: shows a view as in FIG. 3 with a mating flap roll in a position such that an envelope without self-adhesive glue and without a mating flap can be moved to the stationary stop without contact or virtually without contact.

A folding product in the shape of an envelope 1 has, according to FIG. 1, a sealing flap 2 which has not yet been folded over, with a crease 2′ and with self-adhesive glue 2″, and also a mating flap 3 not yet folded over with an associated crease 3′ and with self-adhesive glue 3″. In this state, the envelopes 1 are supplied individually one after another with the bottom edge 4 leading to an apparatus 5 according to FIG. 3 for folding over the sealing flap 2 and mating flap 3.

The apparatus 5 comprises a mating flap roll 6 having a suction element 7 and a sealing flap roll 8 having a suction element 9. Also provided is a holding and guiding element 10 with a stop 11. Further rolls 12 and 13 and 14 and 15 respectively with or without suction elements 16, are used to supply the not yet completed envelope 1 and to transport the completed envelope 1′ onward according to FIG. 2 with the sealing flap 2 and mating flap 3 folded over in each case.

The envelope 1 conveyed into the apparatus S with the bottom edge 4 leading first encounters the holding and guiding element 10 and is then stopped on the stop 11. Previously, the suction element 7 on the mating flap roll 6 has gripped the mating flap 3 and, in the same way, the suction element 9 on the sealing flap roll 8 has gripped the sealing flap 2 (FIG. 4). The sealing flap roll 8 pulls the envelope 1 out of the holding and guiding element 10 once it has reached the position illustrated in FIG. 4, while the mating flap roll 6 continues to rotate in the clockwise direction and releases the mating flap 3 immediately after the latter has reached the position illustrated in FIG. 4. During the further movement of the envelope 1, the sealing flap 2 and the mating flap 3 are folded over completely, as illustrated in FIG. 5. With its suction element 16, the roll 15 then picks up the completed envelope 1′ and delivers it into a tray. The method sequence outlined takes place in the case of all envelopes 1 in each case having self-adhesive glue and having sealing flaps 2 and mating flaps 3 that have not yet been folded over.

The suction element 7 is a suction bar 21 having suction openings 20 and an approximately segment-shaped cross section. The suction element 7 also includes a stop 22, against which the mating flap 3 rests for a time with its free edge 23 (FIG. 4).

The suction openings 20 in the suction bar 21 are driven under cyclic control with the aid of a vacuum generator, which is known in principle and for this reason is not of specific interest here, and by a suitable, in principle likewise known, vacuum control device.

According to the exemplary embodiment shown in the figures, a suction element 7 is arranged on the mating flap roll 6 and projects beyond a cylindrical circumference 24 of the mating flap roll 6. This applies not only to the stop 22 but, in particular, also to the position of the suction openings 20 in a surface which extends parallel to the axis of the mating flap roll 6, radially outside the cylindrical circumference 26. The radius r which substantially determines the cylindrical circumference 24 of the mating flap roll 6 is therefore at least partly considerably smaller than the radius R on which the suction openings 20 lie (FIG. 5)).

The diameter reduction for the cylindrical circumference 24 helps to achieve the situation where a folding product or an envelope 1 (according to FIG. 6) can be transported to the holding and guiding element 10 and its stop 11 without contact or virtually without contact with the mating flap roll 6. In this case, too, the sealing flap roll 8 with its suction element 9 grips the sealing flap 2 as in the case described first and places it into the sealing position.

1. Apparatus for folding folding products with sealing flaps (2) and with or without mating flaps (3) especially on packaging bags including envelopes (1) with/without self-adhesive glue, it being possible for the envelopes (1) to be moved against a stationary stop (11) and for the mating flaps (3) and the sealing flaps (2) then to be turned over by suction elements (7, 9) during a subsequent movement of the envelopes (1), said suction elements (7, 9) being arranged on a mating flap roll (6) and on a sealing flap roll (8),
wherein the radius (r) of the mating flap roll (6) which bears the suction element (7) that turns the mating flaps (3) over, is at least partly small, and
wherein the mating flap roll (6) can be locked, both in such a way that a folding product can be moved past it to the stationary stop (11) without contact or virtually without contact.

2. The apparatus as claimed in claim 1, wherein at least one suction element (7) is arranged on the mating flap roll (6) and projects beyond a cylindrical circumference (24) of the mating flap roll (6).

3. The apparatus as claimed in claim 1 and 2, wherein the suction element (7) is a suction bar (21) having suction openings (20) and a segment-shaped cross section, and has a stop (22).
